(19) United States
(12) Patent Application Publication
(10) Pub. No.: US 2026/0004804 A1
(43) Pub. Date: Jan. 1, 2026

(54) MAGNETIC HEAD AND MAGNETIC RECORDING DEVICE

(71) Applicant: KABUSHIKI KAISHA TOSHIBA, Tokyo (JP)

(72) Inventors: Yuji NAKAGAWA, Kawasaki Kanagawa (JP); Satoshi SHIROTORI, Yokohama Kanagawa (JP); Yoshihiro HIGASHI, Komatsu Ishikawa (JP); Akira KIKITSU, Yokohama Kanagawa (JP)

(73) Assignee: KABUSHIKI KAISHA TOSHIBA, Tokyo (JP)

(21) Appl. No.: 19/241,741

(22) Filed: Jun. 18, 2025

(30) Foreign Application Priority Data
Jul. 1, 2024 (JP) 2024-106417

(51) Int. Cl. G11B 5/11

(52) U.S. Cl. CPC G11B 5/11

(57) ABSTRACT

According to one embodiment, a magnetic head includes a reproducing section including a first reproducing element. The first reproducing element includes first to fourth shields, a first magnetic member, and third and fourth conductive members. The first magnetic member is provided between the first shield and the second shield, and between the third shield and the fourth shield. The first magnetic member includes a first portion and a second portion. The fourth conductive member includes a first conductive portion. A first distance in a third direction between the first end and the third conductive member is shorter than a second distance in the third direction between the second end and the first conductive portion. The third direction crosses a plane including the first direction and the second direction.

### CROSS-REFERENCE TO RELATED APPLICATIONS

This application is based upon and claims the benefit of priority from Japanese Patent Application No. 2024-106417, filed on Jul. 1, 2024; the entire contents of which are incorporated herein by reference.

### FIELD

Embodiments described herein relate generally to a magnetic head and a magnetic recording device.

### BACKGROUND

A magnetic head including a magnetic sensor using a magnetic layer is used to record information on a magnetic recording medium such as an HDD (Hard Disk Drive). Improved characteristics of the magnetic head are desired.

### BRIEF DESCRIPTION OF THE DRAWINGS

FIGS. 1A and 1B are schematic views illustrating a magnetic head according to a first embodiment;

FIG. 2 is a schematic cross-sectional view illustrating the magnetic head according to the first embodiment;

FIG. 3 is a schematic cross-sectional view illustrating a magnetic head according to the first embodiment;

FIG. 4 is a schematic cross-sectional view illustrating a magnetic head according to the first embodiment;

FIG. 5 is a schematic cross-sectional view illustrating a magnetic head according to the first embodiment;

FIG. 6 is a schematic cross-sectional view illustrating a magnetic head according to the first embodiment;

FIG. 7 is a schematic cross-sectional view illustrating a magnetic head according to the first embodiment;

FIG. 8 is a schematic cross-sectional view illustrating a magnetic head according to the first embodiment;

FIG. 9 is a schematic perspective view illustrating a magnetic head and a magnetic recording device according to the embodiment;

FIG. 10 is a schematic perspective view illustrating a part of the magnetic recording device according to the embodiment;

FIG. 11 is a schematic perspective view illustrating the magnetic recording device according to the embodiment; and

FIGS. 12A and 12B are schematic perspective views illustrating a part of the magnetic recording device according to the embodiment.

### DETAILED DESCRIPTION

According to one embodiment, a magnetic head includes a reproducing section including a first reproducing element. The first reproducing element includes a first shield, a second shield, a third shield, a fourth shield, a first magnetic member, a third conductive member, and a fourth conductive member. A second direction from the third shield to the fourth shield crosses a first direction from the first shield to the second shield. The first magnetic member is provided between the first shield and the second shield, and between the third shield and the fourth shield. The first magnetic member includes a first portion and a second portion. The third conductive member is electrically connected to the first portion. The third conductive member is non-magnetic. The fourth conductive member is electrically connected to the second portion. The fourth conductive member being non-magnetic. The fourth conductive member includes a first conductive portion. A first position of the third conductive member in the second direction is between a position of the third shield in the second direction and a fourth shield position of the fourth shield in the second direction. A second position of the first conductive portion in the second direction is between the first position and the fourth shield position. The third shield includes a first end corresponding to a medium facing face. The fourth shield includes a second end corresponding to the medium facing face. A first distance in a third direction between the first end and the third conductive member is shorter than a second distance in the third direction between the second end and the first conductive portion. The third direction crosses a plane including the first direction and the second direction.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

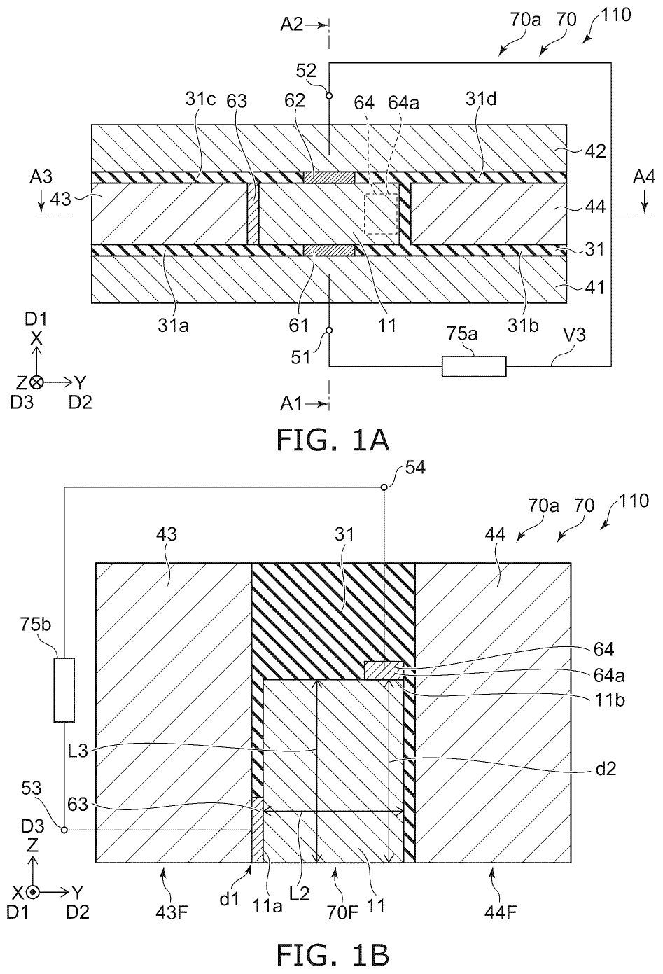

FIGS. 1A and 1B are schematic views illustrating a magnetic head according to a first embodiment.

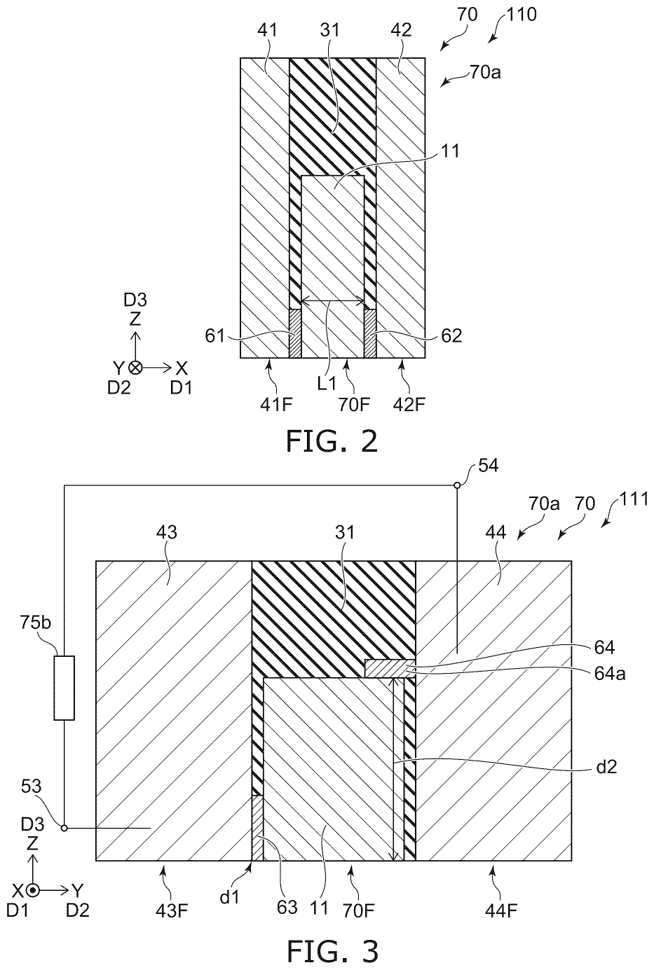

FIG. 2 is a schematic cross-sectional view illustrating the magnetic head according to the first embodiment.

FIG. 1A is a plan view. FIG. 1B is a cross-sectional diagram along the line A3-A4 in FIG. 1A. FIG. 2 is a cross-sectional view along the line A1-A2 in FIG. 1A.

As shown in FIG. 1, a magnetic head 110 according to the embodiment includes a reproducing section 70. The reproducing section 70 includes a first reproducing element 70a. The first reproducing element 70a includes a first shield 41, a second shield 42, a third shield 43, a fourth shield 44, a first magnetic member 11, a third conductive member 63, and a fourth conductive member 64. As will be described below, the first reproducing element 70a may include a first conductive member 61 and a second conductive member 62.

A second direction D2 from the third shield 43 to the fourth shield 44 crosses a first direction D1 from the first shield 41 to the second shield 42.

In this example, the first direction D1 is defined as an X-axis direction. One direction perpendicular to the X-axis direction is defined as a Y-axis direction. A direction perpendicular to the X-axis and Y-axis directions is defined as a Z-axis direction. The second direction D2 is, for example, the Y-axis direction.

The X-axis direction corresponds, for example, to a down-track direction. The Y-axis direction corresponds, for example, to a cross-track direction. The Z-axis direction corresponds, for example, to a height direction.

The first magnetic member 11 is provided between the first shield 41 and the second shield 42, and between the third shield 43 and the fourth shield 44. As shown in FIG. 1B, the first magnetic member 11 includes a first portion 11a and a second portion 11b.

The third conductive member 63 is electrically connected to the first portion 11a. The third conductive member 63 is non-magnetic. The fourth conductive member 64 is electrically connected to the second portion 11b. The fourth conductive member 64 is non-magnetic.

The fourth conductive member 64 includes a first conductive portion 64a. A first position in the second direction D2 of the third conductive member 63 is between a position in the second direction D2 of the third shield 43 and a fourth shield position in the second direction D2 of the fourth shield 44. A second position in the second direction D2 of the first conductive portion 64a is between the first position and the fourth shield position.

As shown in FIG. 1B, the first reproducing element 70a includes a medium facing face 70F. The medium facing face 70F faces a magnetic recording medium from which information is reproduced by the magnetic head 110. FIG. 1A corresponds to a plan view of the first reproducing element 70a looking at the medium facing face 70F. As shown in FIG. 1B, the third shield 43 includes a first end 43F corresponding to the medium facing face 70F. The fourth shield 44 includes a second end 44F corresponding to the medium facing face 70F. A first distance d1 in a third direction D3 between the first end 43F and the third conductive member 63 is shorter than a second distance d2 in the third direction D3 between the second end 44F and the first conductive portion 64a. The third direction D3 crosses a plane including the first direction D1 and the second direction D2. The third direction D3 is, for example, the Z-axis direction.

The first distance d1 may be zero. The second distance d2 is longer than the first distance d1. The position of the first conductive portion 64a in the height direction is different from the position of the third conductive member 63 in the height direction.

As shown in FIG. 1A, the first reproducing element 70a may further include the first conductive member 61 and the second conductive member 62. The first conductive member 61 is provided between the first shield 41 and the first magnetic member 11 in the first direction D1. The second conductive member 62 is provided between the first magnetic member 11 and the second shield 42 in the first direction D1. The first conductive member 61 and the second conductive member 62 are non-magnetic. For example, the first shield 41 may be electrically connected to a part of the first magnetic member 11 via the first conductive member 61. For example, the second shield 42 may be electrically connected to another part of the first magnetic member 11 via the second conductive member 62.

For example, the third conductive member 63 may be provided between the third shield 43 and the first magnetic member 11. The third conductive member 63 may be electrically connected to the third shield 43.

As shown in FIGS. 1A and 1B, in one example, the first reproducing element 70a includes a first terminal 51, a second terminal 52, a third terminal 53, and a fourth terminal 54. The first terminal 51 is electrically connected to the first shield 41. The second terminal 52 is electrically connected to the second shield 42. The third terminal 53 is electrically connected to the third shield 43. The fourth terminal 54 is electrically connected to the fourth conductive member 64.

For example, a voltage (electrical signal) between the third terminal 53 and the fourth terminal 54 is configured to change in response to the magnetic field to be detected when a current flows between the first terminal 51 and the second terminal 52. Such a change in voltage (electrical signal) is thought to be caused by, for example, the anomalous Hall effect.

For example, the current is supplied by the first circuit 75a. The voltage (electrical signal) is detected by the second circuit 75b. Thereby, it becomes possible to detect the magnetic field to be detected. The magnetic field to be detected is based on, for example, information recorded on a magnetic recording medium.

In the embodiment, the first circuit 75a and the second circuit 75b may be considered to be included in the magnetic head 110 for convenience. The first circuit 75a and the second circuit 75b may be provided separately from the magnetic head 110. These circuits may be included in the magnetic recording device. For example, the first circuit 75a includes a current source. The second circuit 75b includes, for example, a voltmeter.

As described above, in the embodiment, the position in the height direction of the first conductive portion 64a of the fourth conductive member 64 is different from the position in the height direction of the third conductive member 63. With this configuration, the direction connecting the third conductive member 63 and the first conductive portion 64a is inclined with respect to the X-Y plane. As a result, the voltage (electrical signal) generated between the third conductive member 63 and the first conductive portion 64a corresponds to the magnetization of the component of the first magnetic member 11 crossing the third direction D3. The above voltage (electrical signal) may correspond to, for example, the magnetization of the component of the first magnetic member 11 being inclined with respect to the third direction D3.

For example, the magnetic recording medium may be a perpendicular magnetic recording medium. The magnetic recording medium includes a first recording region and a second recording region. These recording regions are next to each other in the cross-track direction (for example, the second direction D2). When the magnetization direction of the first recording region and the magnetization direction of the second recording region are different from each other, the magnetic field emitted from these recording regions includes a component in a direction crossing the third direction D3 (for example, a direction inclined with respect to the third direction D3). In the embodiment, the direction connecting the third conductive member 63 and the first conductive portion 64a is inclined with respect to the X-Y plane. Therefore, the signal obtained from these conductive members changes with higher sensitivity according to the inclined component of the magnetic field emitted from the two recording regions of the magnetic recording medium. In the embodiment, high sensitivity detection is possible. Thereby, a higher recording density can be obtained. According to the embodiment, a magnetic head capable of improving characteristics can be provided.

As shown in FIG. 1B, in this example, the first conductive portion 64a does not overlap the third conductive member 63 in the second direction D2. Thereby, more effective detection of the inclined component of the magnetic field emitted from the magnetic recording medium can be possible.

As described above, the first magnetic member 11 has, for example, the anomalous Hall effect. For example, the first magnetic member 11 may include at least one selected from the group consisting of Co₂MnGa, Co₂MnAl, FePt, MnGa, Mn₃Sn, Mn₃Ge, Mn₃Ga, RuO₂, MnTe, CrSb, and Mn₅Si₃. With these materials, for example, the anomalous Hall effect can be effectively obtained. The first magnetic member 11 may include a Weyl ferromagnet. The first magnetic member 11 may include an L10 ordered alloy. The first magnetic member 11 may include a Weyl antiferromagnet. The first magnetic member 11 may include an altermagnet material.

In one example, at least one of the first conductive member 61, the second conductive member 62, the third conductive member 63, and the fourth conductive member 64 may include at least one selected from the group consisting of Cu, Au, Ag, Pt, Al, Pd, Ta, Ru, Hf, W, Mo, Ir, Cr, Tb, and Rh. These materials can, for example, suppress the effect of spin between the shields and the first magnetic member 11. High sensitivity is easily obtained.

As shown in FIG. 1A, in this example, in the first direction D1, the third shield 43 is between a part of the first shield 41 and a part of the second shield 42. In the first direction D1, the fourth shield 44 is between another part of the first shield 41 and another part of the second shield 42.

The first shield 41 is, for example, a leading shield. The second shield 42 is, for example, a trailing shield. The third shield 43 is at least a part of a side shield. The fourth shield 44 is at least a part of the side shield.

The first shield 41 is, for example, a bottom shield. The second shield 42 is, for example, a top shield. The third shield 43 is at least a part of the side bias layer. The fourth shield 44 is at least a part of the side bias layer.

As shown in FIG. 1A, the first reproducing element 70a may further include a first insulating member 31. The first insulating member 31 includes a first insulating region 31a and a second insulating region 31b. At least a part of the first insulating region 31a is provided between a part of the first shield 41 and the third shield 43. At least a part of the second insulating region 31b is provided between another part of the first shield 41 and the fourth shield 44.

As shown in FIG. 1, the first insulating member 31 may further include a third insulating region 31c and a fourth insulating region 31d. At least a part of the third insulating region 31c is provided between the third shield 43 and a part of the second shield 42. At least a part of the fourth insulating region 31d is provided between the fourth shield 44 and another part of the second shield 42.

As shown in FIGS. 1B and 2, a direction from the first magnetic member 11 to a part of the first insulating member 31 may be along the third direction D3. A part of the first insulating member 31 may be provided between the first shield 41 and the second shield 42. A part of the first insulating member 31 may be provided between the third shield 43 and the fourth shield 44.

As shown in FIG. 1B, a length of the first magnetic member 11 along the third direction D3 is defined as a length L3. A length of the first magnetic member 11 along the second direction D2 is defined as a length L2. For example, the length L3 may be longer than the length L2. For example, by shape anisotropy, the component of the magnetization of the first magnetic member 11 along the third direction D3 becomes larger. Thereby, it becomes easier to detect the magnetic field to be detected with higher sensitivity.

As shown in FIG. 2, a length of the first magnetic member 11 along the first direction D1 is defined as a length L1. For example, the length L3 may be longer than the length L1. For example, by shape anisotropy, the component of the magnetization of the first magnetic member 11 along the third direction D3 becomes larger. Thereby, it becomes easier to detect the magnetic field to be detected with higher sensitivity. The length L2 may be longer than the length L1.

FIG. 3 is a schematic cross-sectional view illustrating a magnetic head according to the first embodiment.

As shown in FIG. 3, in a magnetic head 111 according to the embodiment, the configuration of the fourth conductive member 64 differs from that in the magnetic head 110. Except for this, the configuration of the magnetic head 111 may be the same as the configuration of the magnetic head 110.

In the magnetic head 111, the fourth conductive member 64 contacts the first magnetic member 11 and the fourth shield 44. The fourth conductive member 64 is electrically connected to the first magnetic member 11 and the fourth shield 44. In this case, the fourth terminal 54 may be electrically connected to the fourth shield 44. In the magnetic head 111 as well, the signal generated between the third conductive member 63 and the first conductive portion 64a changes with higher sensitivity in response to the inclined components of the magnetic field emitted from two recording regions of the magnetic recording medium. The inclined components of magnetization can be detected with high sensitivity. High sensitivity detection is possible.

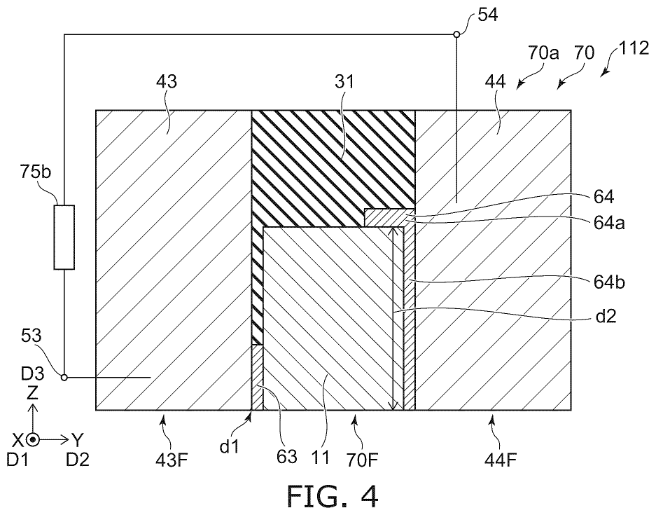

FIG. 4 is a schematic cross-sectional view illustrating a magnetic head according to the first embodiment.

As shown in FIG. 4, in a magnetic head 112 according to the embodiment, the configuration of the fourth conductive member 64 differs from that in the magnetic head 111. Except for this, the configuration of the magnetic head 112 may be the same as the configuration of the magnetic head 111.

In the magnetic head 112, the fourth conductive member 64 includes a second conductive portion 64b. The second conductive portion 64b is connected to the first conductive portion 64a. The second conductive portion 64b is provided between at least a part of the first magnetic member 11 and at least a part of the fourth shield 44 in the second direction D2. In the magnetic head 112 as well, the signal generated between the third conductive member 63 and the fourth conductive member 64 changes with higher sensitivity in response to the inclined components of the magnetic fields emitted from two recording regions of the magnetic recording medium. The inclined components of magnetization can be detected with high sensitivity. High sensitivity detection is possible.

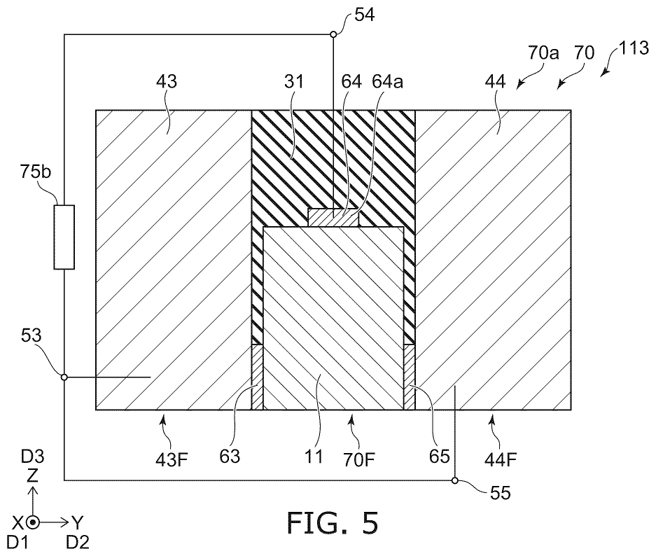

FIG. 5 is a schematic cross-sectional view illustrating a magnetic head according to the first embodiment.

As shown in FIG. 5, in a magnetic head 113 according to the embodiment, the third terminal 53 is electrically connected to the fourth shield 44. Except for this, the configuration of the magnetic head 112 may be the same as the configuration of the magnetic head 110, for example.

In the magnetic head 113, noise can be further reduced. For example, the inclined components of the magnetic field emitted from two recording regions of the magnetic recording medium can be detected with higher sensitivity. For example, the magnetization of the two recording regions in the cross-track direction can be detected with higher accuracy.

In the magnetic head 113, the first reproducing element 70a may further include a fifth conductive member 65. The fifth conductive member 65 is provided between the first magnetic member 11 and the fourth shield 44 in the second direction D2. The fifth conductive member 65 is electrically connected to the first magnetic member 11 and the fourth shield 44. The first reproducing element 70a may further include a fifth terminal 55. The fifth terminal 55 is electrically connected to the fourth shield 44. In the magnetic head 113, the fifth terminal 55 is electrically connected to the third terminal 53.

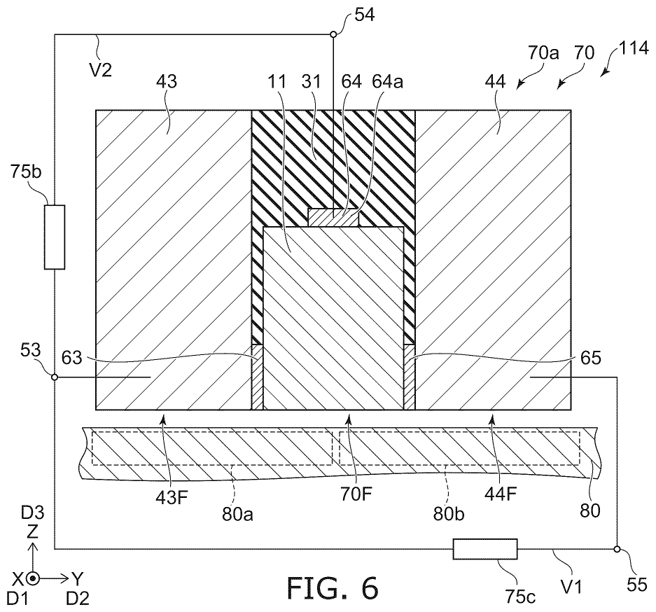

FIG. 6 is a schematic cross-sectional view illustrating a magnetic head according to the first embodiment.

As shown in FIG. 6, in a magnetic head 114 according to the embodiment, the fifth terminal 55 is not connected to the third terminal 53. Except for this, the configuration of the magnetic head 114 may be the same as the configuration of the magnetic head 113, for example.

In the magnetic head 114, the first reproducing element 70a includes the fifth terminal 55 electrically connected to the fourth shield 44. In the magnetic head 114, the first signal V1 (voltage) between the third terminal 53 and the fifth terminal 55 is configured to change in response to the magnetic field to be detected when a current flows between the first terminal 51 and the second terminal 52 (see FIG. 1A). The second signal V2 (voltage) between the third terminal 53 and the fourth terminal 54 is configured to change in response to the magnetic field to be detected when a current flows between the first terminal 51 and the second terminal 52.

For example, the second signal V2 between the third terminal 53 and the fourth terminal 54 may be detected by the second circuit 75b. For example, the first signal V1 between the third terminal 53 and the fifth terminal 55 may be detected by the third circuit 75c. Based on the first signal V1 and the second signal V2, information recorded on the magnetic recording medium can be reproduced. For example, the state of two recording regions next to each other in the cross-track direction can be detected by the first signal V1 and the second signal V2.

As shown in FIG. 6, for example, the first end 43F and the second end 44F face the magnetic recording medium 80. The magnetic recording medium 80 includes a first recording region 80a and a second recording region 80b. A direction from the first recording region 80a to the second recording region 80b is along the second direction D2. The magnetic field to be detected by the first reproducing element 70a depends on a state of the first recording region 80a and a state of the second recording region 80b.

For example, the first signal V1 corresponds to a first component along the third direction D3 of the magnetic field generated by the first magnetization of the first recording region 80a and the second magnetization of the second recording region 80b. The second signal V2 corresponds to a second component along the second direction D2 of the magnetic field generated by the first magnetization of the first recording region 80a and the second magnetization of the second recording region 80b. For example, the first signal V1 corresponds to, for example, a perpendicular component. The second signal V2 corresponds to, for example, a horizontal component.

For example, when the orientation of the component of the first magnetization in the first recording region 80a along the third direction D3 is the same as the orientation of the component of the second magnetization in the second recording region 80b along the third direction D3, the first component along the third direction D3 is likely to be generated. For example, when the orientation of the component of the first magnetization in the first recording region 80a along the third direction D3 is opposite to the orientation of the component of the second magnetization in the second recording region 80b along the third direction D3, the second component of the magnetic field along the second direction D2 is likely to be generated.

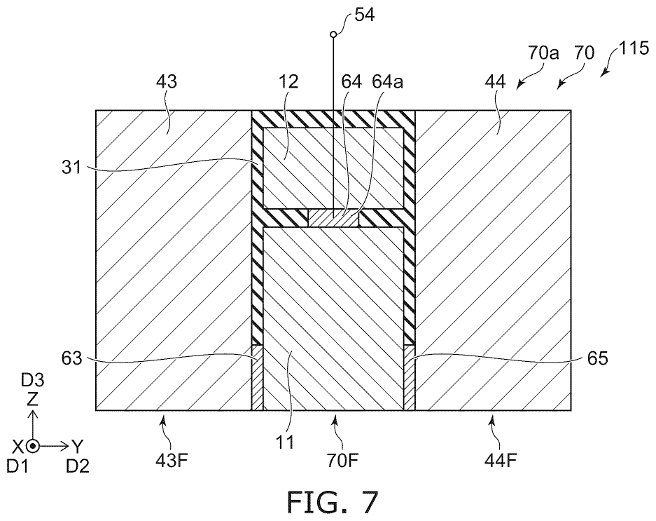

FIG. 7 is a schematic cross-sectional view illustrating a magnetic head according to the first embodiment.

As shown in FIG. 7, in a magnetic head 115 according to the embodiment, the first reproducing element 70a includes a second magnetic member 12. Except for this, the configuration of the magnetic head 115 may be the same as the configuration of the magnetic head 113, for example.

In the magnetic head 115, the first reproducing element 70a includes the second magnetic member 12 in addition to the first magnetic member 11. A direction from the first magnetic member 11 to the second magnetic member 12 is along the third direction D3. For example, the first conductive portion 64a is between the first magnetic member 11 and the second magnetic member 12 in the third direction D3. The second magnetic member 12 includes, for example, IrMn. The magnetization of the first magnetic member 11 is effectively controlled by the second magnetic member 12. For example, the component of the magnetization of the first magnetic member 11 along the third direction D3 can be increased.

In the magnetic heads 111 to 115, the first circuit 75a and the second circuit 75b can be interchanged. For example, the first circuit 75a may include a voltmeter, and the second circuit 75b may include a current source.

In the magnetic heads 111 to 115, a current may be supplied between the first terminal 51 and the second terminal 52, and a third signal V3 (e.g., a third voltage, see FIG. 1A) between the first terminal 51 and the second terminal 52 may change in response to the magnetic field to be detected. Such a change in the electrical signal (voltage) is considered to be caused by, for example, at least one of the anisotropic magnetoresistance effect or the giant magnetoresistance effect. The first circuit 75a may further include a voltmeter. For example, the third signal V3 may correspond to a first component along the third direction D3 of the magnetic field generated by the first magnetization of the first recording region 80a and the second magnetization of the second recording region 80b.

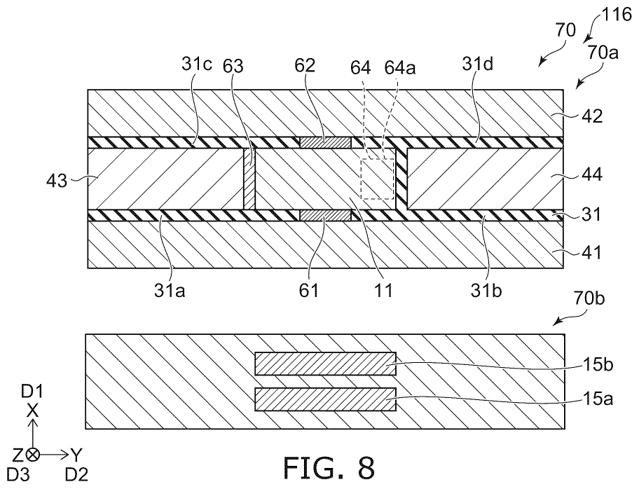

FIG. 8 is a schematic cross-sectional view illustrating a magnetic head according to the first embodiment.

As shown in FIG. 8, in a magnetic head 116 according to the embodiment, the reproducing section 70 includes a second reproducing element 70b. Except for this, the configuration of the magnetic head 116 may be the same as the configuration of the magnetic head 110, for example.

In the magnetic head 116, the reproducing section 70 includes the second reproducing element 70b in addition to the first reproducing element 70a. In this example, a direction from the second reproducing element 70b to the first reproducing element 70a is along the first direction D1.

The reproducing section 70 may be configured to perform a reproducing operation based on a first reproducing signal obtained from the first reproducing element 70a and a second reproducing signal obtained from the second reproducing element 70b.

For example, the first reproducing signal corresponds to a second component along the second direction D2 of the magnetic field generated by the first magnetization of the first recording region 80a and the second magnetization of the second recording region 80b. For example, the second reproducing signal corresponds to a first component along the third direction D3 of the magnetic field generated by the first magnetization of the first recording region 80a and the second magnetization of the second recording region 80b. The first reproducing signal corresponds to, for example, a horizontal component. The second reproducing signal corresponds to, for example, a perpendicular component.

As shown in FIG. 8, the second reproducing element 70b may include a first magnetic layer 15a. In the second reproducing element 70b, the anomalous Hall effect may be used. The second reproducing element 70b may include a second magnetic layer 15b. A direction from the first magnetic layer 15a to the second magnetic layer 15b is along the first direction D1. In the second reproducing element 70b, for example, a TMR effect may be used. For example, a GMR effect may be used. For example, the AMR effect (anisotropic magnetoresistance effect) may be used.

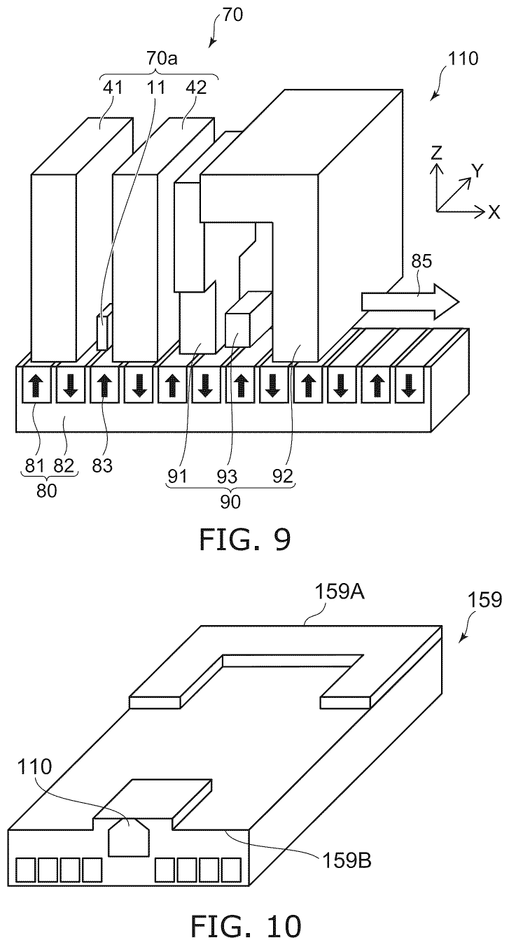

FIG. 9 is a schematic perspective view illustrating a magnetic head and a magnetic recording device according to the embodiment.

As shown in FIG. 9, the magnetic head according to the embodiment (e.g., the magnetic head 110) includes the reproducing section 70. The reproducing section 70 includes the first reproducing element 70a. The reproducing section 70 may further include other reproducing elements (e.g., the second reproducing element 70b, etc.). The magnetic head 110 is used together with the magnetic recording medium 80. The magnetic head 110 may include a recording section 90. Information is recorded on the magnetic recording medium 80 by the recording section 90 of the magnetic head 110. The information recorded on the magnetic recording medium 80 is reproduced by the reproducing section 70.

The magnetic recording medium 80 includes, for example, a medium substrate 82 and a magnetic recording layer 81 provided on the medium substrate 82. The magnetization 83 of the magnetic recording layer 81 is controlled by the recording section 90. The recording section 90 includes, for example, a first magnetic pole 91 and a second magnetic pole 92. The first magnetic pole 91 is, for example, a main magnetic pole. The second magnetic pole 92 is, for example, a trailing shield. The recording section 90 may include a recording section element 93. The recording section element 93 may include a magnetic field control element or a high-frequency oscillation element. The recording section element 93 may be omitted.

The first reproducing element 70a of the reproducing section 70 includes, for example, the first shield 41, the second shield 42, and the first magnetic member 11. In FIG. 9, the third shield 43 and the fourth shield 44 are omitted. The reproducing section 70 can output a signal corresponding to the magnetization 83 of the magnetic recording layer 81.

As shown in FIG. 9, the magnetic recording medium 80 moves relative to the magnetic head 110 in a medium movement direction 85. The magnetic head 110 controls information corresponding to the magnetization 83 of the magnetic recording layer 81 at desired position. The magnetic head 110 reproduces information corresponding to the magnetization 83 of the magnetic recording layer 81 at desired position.

For example, the medium movement direction 85 is the direction from the first shield 41 to the second shield 42. For example, the magnetic recording medium 80 includes one recording region (first region). After the first region faces the first shield 41, the first region faces the second shield 42.

For example, a direction from the reproducing section 70 to the recording section 90 is along the first direction D1. For example, the second shield 42 is between the first magnetic member 11 and the recording section 90. For example, the second conductive member 62 is between the first magnetic member 11 and the recording section 90.

The recording section 90 may be configured to record in the first recording region 80a and the second recording region 80b so that the timing of data switching in the first direction is synchronized. In this example, the direction from the first recording region 80a to the second recording region 80b is along the second direction D2.

FIG. 10 is a schematic perspective view illustrating a part of the magnetic recording device according to the embodiment.

FIG. 10 illustrates a head slider.

The magnetic head 110 is provided on the head slider 159. The head slider 159 includes, for example, Al₂O₃/TIC or the like. The head slider 159 moves relative to the magnetic recording medium while floating or in contact with the magnetic recording medium.

The head slider 159 includes, for example, an air inflow side 159A and an air outflow side 159B. The magnetic head 110 is arranged on the side surface of the air outflow side 159B of the head slider 159 or the like. As a result, the magnetic head 110 moves relative to the magnetic recording medium while flying above or in contact with the magnetic recording medium.

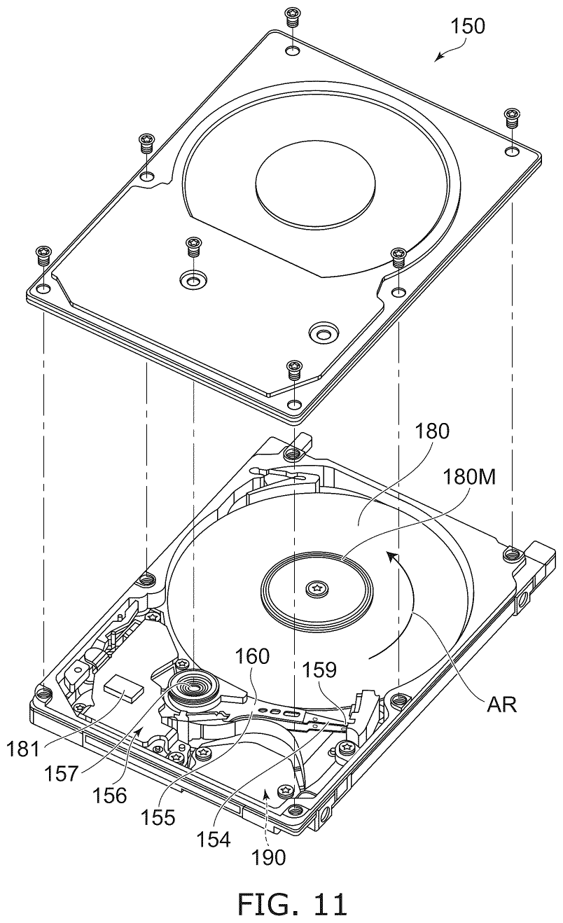

FIG. 11 is a schematic perspective view illustrating the magnetic recording device according to the embodiment.

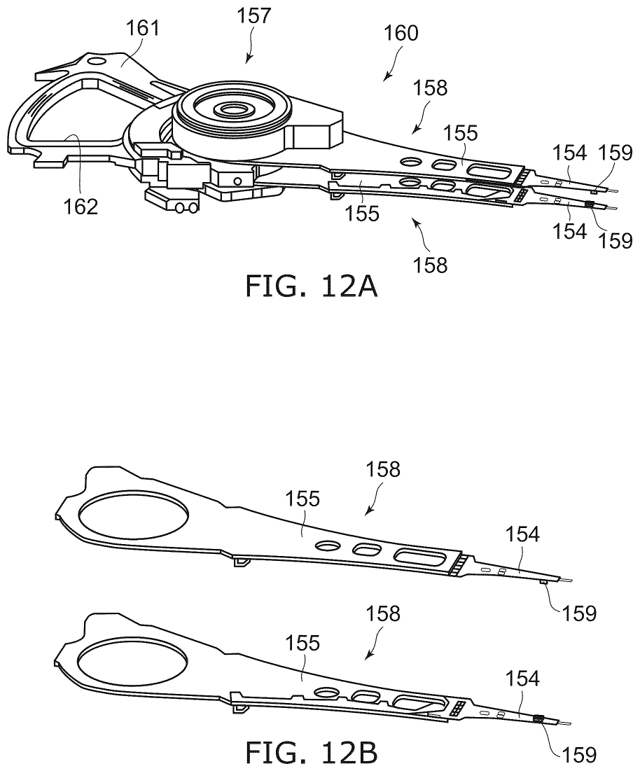

FIGS. 12A and 12B are schematic perspective views illustrating a part of the magnetic recording device according to the embodiment.

As shown in FIG. 11, in a magnetic recording device 150 according to the embodiment, a rotary actuator is used. The recording medium disk 180 is connected to a spindle motor 180M. The recording medium disk 180 is rotated in a direction of arrow AR by the spindle motor 180M. The spindle motor 180M is responsive to control signals from the drive device controller. The magnetic recording device 150 according to the embodiment may include the multiple recording medium disks 180. The magnetic recording device 150 may include a recording medium 181. The recording medium 181 is, for example, an SSD (Solid State Drive). A non-volatile memory such as a flash memory is used for the recording medium 181, for example. For example, the magnetic recording device 150 may be a hybrid HDD (Hard Disk Drive).

The head slider 159 records and reproduces information to be recorded on the recording medium disk 180. The head slider 159 is provided at an end of a thin-film suspension 154. A magnetic head according to the embodiment is provided near the end of the head slider 159.

While the recording medium disk 180 is rotating, the pressing pressure by the suspension 154 and the floating pressure generated at the medium facing face (ABS) of the head slider 159 are balanced. The distance between the medium facing face of the head slider 159 and the surface of the recording medium disk 180 is the predetermined fly height. In the embodiment, the head slider 159 may contact the recording medium disk 180. For example, a contact sliding type may be applied.

The suspension 154 is connected to one end of an arm 155 (e.g., an actuator arm). The arm 155 includes, for example, a bobbin part or the like. The bobbin part holds a drive coil. A voice coil motor 156 is provided at the other end of the arm 155. The voice coil motor 156 is a type of linear motor. The voice coil motor 156 includes, for example, a drive coil and a magnetic circuit. The drive coil is wound on the bobbin part of the arm 155. The magnetic circuit includes permanent magnets and opposing yokes. The drive coil is provided between the permanent magnet and the opposing yoke. The suspension 154 includes one end and the other end. The magnetic head is provided at one end of the suspension 154. The arm 155 is connected to the other end of the suspension 154.

The arm 155 is held by ball bearings. Ball bearings are provided at two locations above and below a bearing part 157. The arm 155 can be rotated and slid by the voice coil motor 156. The magnetic head can move to any position on the recording medium disk 180.

FIG. 12A is an enlarged perspective view of the head stack assembly 160, illustrating the configuration of a part of the magnetic recording device.

FIG. 12B is a perspective view illustrating the magnetic head assembly (head gimbal assembly: HGA) 158 that forms part of the head stack assembly 160.

As shown in FIG. 12A, the head stack assembly 160 includes the bearing part 157, the magnetic head assembly 158 and a support frame 161. The magnetic head assembly 158 extends from the bearing part 157. The support frame 161 extends from the bearing part 157. A direction in which the support frame 161 extends is opposite to a direction in which the magnetic head assembly 158 extends. The support frame 161 supports a coil 162 of the voice coil motor 156.

As shown in FIG. 12B, the magnetic head assembly 158 includes the arm 155 extending from the bearing part 157 and the suspension 154 extending from the arm 155.

The head slider 159 is provided at the end of the suspension 154. The head slider 159 is provided with the magnetic head according to the embodiment.

The magnetic head assembly 158 (head gimbal assembly) according to the embodiment includes the magnetic head according to the embodiment, the head slider 159 provided with the magnetic head, the suspension 154 and the arm 155. The head slider 159 is provided at one end of the suspension 154. The arm 155 is connected to the other end of the suspension 154.

The suspension 154 may include, for example, a wiring (not shown) for recording and reproducing signals. The suspension 154 may include, for example, a heater wiring (not shown) for adjusting the fly height. The suspension 154 may include a wiring (not shown) for, for example, an oscillator element or the like. These wires may be electrically connected to multiple electrodes provided on the magnetic head.

A signal processor 190 is provided in the magnetic recording device 150. The signal processor 190 uses a magnetic head to record and reproduce signals on a magnetic recording medium. Input/output lines of the signal processor 190 are connected to, for example, electrode pads of the magnetic head assembly 158 and electrically connected to the magnetic head.

The magnetic recording device 150 according to the embodiment includes the magnetic recording medium, the magnetic head according to the embodiment, a movable part, a position controller, and a signal processor. The movable part separates the magnetic recording medium from the magnetic head or makes them relatively movable while they are in contact with each other. The position controller aligns the magnetic head with a predetermined recording position on the magnetic recording medium. The signal processor records and reproduces signals on the magnetic recording medium using the magnetic head.

For example, the recording medium disk 180 is used as the above magnetic recording medium. The movable part includes, for example, the head slider 159. The position controller described above includes, for example, the magnetic head assembly 158.

The embodiments may include the following Technical proposals:

### (Technical Proposal 1)

A magnetic head, comprising:
a reproducing section including a first reproducing element, the first reproducing element including:
a first shield;
a second shield;
a third shield;
a fourth shield, a second direction from the third shield to the fourth shield crossing a first direction from the first shield to the second shield;
a first magnetic member provided between the first shield and the second shield, and between the third shield and the fourth shield, the first magnetic member including a first portion and a second portion;
a third conductive member electrically connected to the first portion, the third conductive member being non-magnetic; and
a fourth conductive member electrically connected to the second portion, the fourth conductive member being non-magnetic,
the fourth conductive member including a first conductive portion,
a first position of the third conductive member in the second direction being between a position of the third shield in the second direction and a fourth shield position of the fourth shield in the second direction,
a second position of the first conductive portion in the second direction being between the first position and the fourth shield position,
the third shield including a first end corresponding to a medium facing face,
the fourth shield including a second end corresponding to the medium facing face,
a first distance in a third direction between the first end and the third conductive member being shorter than a second distance in the third direction between the second end and the first conductive portion, and
the third direction crossing a plane including the first direction and the second direction.

### (Technical Proposal 2)

The magnetic head according to Technical proposal 1, wherein
in the first direction, the third shield is between a part of the first shield and a part of the second shield, and
in the first direction, the fourth shield is between another part of the first shield and another part of the second shield.

### (Technical Proposal 3)

The magnetic head according to Technical proposal 1 or 2, wherein the first reproducing element further includes:
a first terminal electrically connected to the first shield;
a second terminal electrically connected to the second shield,
a third terminal electrically connected to the third shield; and
a fourth terminal electrically connected to the fourth conductive member.

### (Technical Proposal 4)

The magnetic head according to Technical proposal 3, wherein
a voltage between the third terminal and the fourth terminal is configured to change in response to a magnetic field to be detected when a current flows between the first terminal and the second terminal.

### (Technical Proposal 5)

The magnetic head according to Technical proposal 3 or 4, wherein
the third terminal is further electrically connected to the fourth shield.

### (Technical Proposal 6)

The magnetic head according to Technical proposal 3, wherein
the first reproducing element further includes a fifth terminal electrically connected to the fourth shield,
a first signal between the third terminal and the fifth terminal is configured to change in response to a magnetic field to be detected when a current flows between the first terminal and the second terminal,
a second signal between the third terminal and the fourth terminal is configured to change in response to the magnetic field to be detected when the current flows between the first terminal and the second terminal.

### (Technical Proposal 7)

The magnetic head according to Technical proposal 6, wherein
the first end and the second end face a magnetic recording medium,
the magnetic recording medium includes a first recording region and a second recording region,
a direction from the first recording region to the second recording region is along the second direction,
the magnetic field to be detected depends on a state of the first recording region and a state of the second recording region.

### (Technical Proposal 8)

The magnetic head according to Technical proposal 7, wherein
the first signal corresponds to a first component of the first magnetization of the first recording region along the third direction and a second component of the second magnetization of the second recording region along the third direction,
the second signal corresponds to a component along the second direction based on the first magnetization and the second magnetization.

### (Technical Proposal 9)

The magnetic head according to Technical proposal 8, further comprising:
a recording section,
the recording section being configured to record in the first recording region and the second recording region so that timings of data switching is synchronized.

### (Technical Proposal 10)

The magnetic head according to any one of Technical proposals 6-9, wherein
the first reproducing element further includes a fifth conductive member,
the fifth conductive member is provided between the first magnetic member and the fourth shield in the second direction,
the fifth conductive member is electrically connected to the first magnetic member and the fourth shield.

### (Technical Proposal 11)

The magnetic head according to Technical proposal 6, wherein
the reproducing section further includes a second reproducing element,
the reproducing section is configured to perform a reproducing operation based on a first reproducing signal obtained from the first reproducing element and a second reproducing signal obtained from the second reproducing element.

### (Technical Proposal 12)

The magnetic head according to any one of Technical proposals 3-11, wherein
the third conductive member is provided between the third shield and the first magnetic member, and
the third conductive member is electrically connected to the third shield.

### (Technical Proposal 13)

The magnetic head according to any one of Technical proposals 3-12, wherein
the fourth conductive member is electrically connected to the fourth shield.

### (Technical Proposal 14)

The magnetic head according to any one of Technical proposals 1-13, wherein
the fourth conductive member includes a second conductive portion,
the second conductive portion is connected to the first conductive portion, and
the second conductive portion is provided between at least a part of the first magnetic member and at least a part of the fourth shield in the second direction.

### (Technical Proposal 15)

The magnetic head according to any one of Technical proposals 1-14, wherein
the first reproducing element further includes a second magnetic member, and
a direction from the first magnetic member to the second magnetic member is along the third direction.

### (Technical Proposal 16)

The magnetic head according to any one of Technical proposals 1-15, wherein
the first reproducing element further includes a first conductive member and a second conductive member,
the first conductive member is provided between the first shield and the first magnetic member in the first direction, and
the second conductive member is provided between the first magnetic member and the second shield in the first direction.

### (Technical Proposal 17)

The magnetic head according to any one of Technical proposals 1-16, wherein
the first magnetic member includes at least one selected from the group consisting of Co₂MnGa, Co₂MnAl, FePt, MnGa, Mn₃Sn, Mn₃Ge, Mn₃Ga, RuO₂, MnTe, CrSb, and Mn₅Si₃.

### (Technical Proposal 18)

The magnetic head according to any one of Technical proposals 1-8, further comprising:
a recording section,
a direction from the reproducing section to the recording section being along the first direction.

### (Technical Proposal 19)

The magnetic head according to any one of Technical proposals 1-18, wherein
a length of the first magnetic member along the third direction is longer than a length of the first magnetic member along the second direction.

### (Technical Proposal 20)

A magnetic recording device, comprising:
the magnetic head according to any one of Technical proposals 1-6; and
a magnetic recording medium,
the reproducing section being configured to reproduce information recorded on the magnetic recording medium.

According to the embodiment, a magnetic head and a magnetic recording device can be provided that can improve characteristics.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in magnetic heads and magnetic recording devices such as shields, magnetic layers, conductive members, terminals, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all magnetic heads and all magnetic recording devices practicable by an appropriate design modification by one skilled in the art based on the magnetic heads and the magnetic recording devices described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A magnetic head, comprising:
a reproducing section including a first reproducing element,
the first reproducing element including:
a first shield;
a second shield;
a third shield;
a fourth shield, a second direction from the third shield to the fourth shield crossing a first direction from the first shield to the second shield;
a first magnetic member provided between the first shield and the second shield, and between the third shield and the fourth shield, the first magnetic member including a first portion and a second portion;
a third conductive member electrically connected to the first portion, the third conductive member being non-magnetic; and
a fourth conductive member electrically connected to the second portion, the fourth conductive member being non-magnetic,
the fourth conductive member including a first conductive portion,
a first position of the third conductive member in the second direction being between a position of the third shield in the second direction and a fourth shield position of the fourth shield in the second direction,
a second position of the first conductive portion in the second direction being between the first position and the fourth shield position,
the third shield including a first end corresponding to a medium facing face,
the fourth shield including a second end corresponding to the medium facing face,
a first distance in a third direction between the first end and the third conductive member being shorter than a second distance in the third direction between the second end and the first conductive portion, and
the third direction crossing a plane including the first direction and the second direction.

2. The magnetic head according to claim 1, wherein
in the first direction, the third shield is between a part of the first shield and a part of the second shield, and
in the first direction, the fourth shield is between another part of the first shield and another part of the second shield.

3. The magnetic head according to claim 1, wherein
the first reproducing element further includes:
a first terminal electrically connected to the first shield;
a second terminal electrically connected to the second shield,
a third terminal electrically connected to the third shield; and
a fourth terminal electrically connected to the fourth conductive member.

4. The magnetic head according to claim 3, wherein
a voltage between the third terminal and the fourth terminal is configured to change in response to a magnetic field to be detected when a current flows between the first terminal and the second terminal.

5. The magnetic head according to claim 3, wherein
the third terminal is further electrically connected to the fourth shield.

6. The magnetic head according to claim 3, wherein
the first reproducing element further includes a fifth terminal electrically connected to the fourth shield,
a first signal between the third terminal and the fifth terminal is configured to change in response to a magnetic field to be detected when a current flows between the first terminal and the second terminal,
a second signal between the third terminal and the fourth terminal is configured to change in response to the magnetic field to be detected when the current flows between the first terminal and the second terminal.

7. The magnetic head according to claim 6, wherein
the first end and the second end face a magnetic recording medium,
the magnetic recording medium includes a first recording region and a second recording region,
a direction from the first recording region to the second recording region is along the second direction,
the magnetic field to be detected depends on a state of the first recording region and a state of the second recording region.

8. The magnetic head according to claim 7, wherein
the first signal corresponds to a first component along the third direction of the magnetic field generated by the first magnetization of the first recording region and the second magnetization of the second recording region, and
the second signal corresponds to a second component along the second direction of the magnetic field generated by the first magnetization of the first recording region and the second magnetization of the second recording region.

9. The magnetic head according to claim 4, wherein
the first end and the second end face a magnetic recording medium,
the magnetic recording medium includes a first recording region and a second recording region,
a direction from the first recording region to the second recording region is along the second direction,
the magnetic field to be detected depends on a state of the first recording region and a state of the second recording region.

10. The magnetic head according to claim 9, wherein
a voltage between the third terminal and the fourth terminal corresponds to a second component along the second direction of the magnetic field generated by the first magnetization of the first recording region and the second magnetization of the second recording region.

11. The magnetic head according to claim 8, further comprising:
a recording section,
the recording section being configured to record in the first recording region and the second recording region so that timings of data switching in the first direction is synchronized.

12. The magnetic head according to claim 6, wherein
the first reproducing element further includes a fifth conductive member,
the fifth conductive member is provided between the first magnetic member and the fourth shield in the second direction,
the fifth conductive member is electrically connected to the first magnetic member and the fourth shield.

13. The magnetic head according to claim 6, wherein
the reproducing section further includes a second reproducing element,
the reproducing section is configured to perform a reproducing operation based on a first reproducing signal obtained from the first reproducing element and a second reproducing signal obtained from the second reproducing element.

14. The magnetic head according to claim 3, wherein
the third conductive member is provided between the third shield and the first magnetic member, and
the third conductive member is electrically connected to the third shield.

15. The magnetic head according to claim 3, wherein
the fourth conductive member is electrically connected to the fourth shield.

16. The magnetic head according to claim 1, wherein
the fourth conductive member includes a second conductive portion,
the second conductive portion is connected to the first conductive portion, and
the second conductive portion is provided between at least a part of the first magnetic member and at least a part of the fourth shield in the second direction.

17. The magnetic head according to claim 1, wherein
the first reproducing element further includes a second magnetic member, and
a direction from the first magnetic member to the second magnetic member is along the third direction.

18. The magnetic head according to claim 1, wherein
the first magnetic member includes at least one selected from the group consisting of Co₂MnGa, Co₂MnAl, FePt, MnGa, Mn₃Sn, Mn₃Ge, Mn₃Ga, RuO₂, MnTe, CrSb, and Mn₅Si₃.

19. The magnetic head according to claim 1, further comprising:
a recording section,
a direction from the reproducing section to the recording section being along the first direction.

20. A magnetic recording device, comprising:
the magnetic head according to claim 1; and
a magnetic recording medium,
the reproducing section being configured to reproduce information recorded on the magnetic recording medium.
